(19) United States
(12) Patent Application Publication
(10) Pub. No.: US 2012/0317793 A1
(43) Pub. Date: Dec. 20, 2012

(54) METHOD OF FORMING ANTENNA BY SPUTTERING AND LITHOGRAPHY

(76) Inventor: Chung-Yen Yang, New Taipei City (TW)

(21) Appl. No.: 13/526,557

(22) Filed: Jun. 19, 2012

(30) Foreign Application Priority Data
Jun. 20, 2011 (TW) 100121464
Jun. 19, 2012 (TW) 101121923

(51) Int. Cl. H01P 11/00

(52) U.S. Cl. 29/600

(57) ABSTRACT

A method of forming an antenna includes molding a supporting body, sputtering a conductive layer onto the supporting body, and defining a pattern of the antenna on the conductive layer. The step of molding the supporting body includes molding the supporting body having a non-planar surface. The step of defining the pattern of the antenna on the conductive layer includes defining part of the pattern of the antenna on part of the conductive layer sputtered on the non-planar surface. The method of forming the antenna further includes performing metallization or chemical plating on the formed antenna.

### BACKGROUND OF THE INVENTION

1. Field of the Invention

The present invention relates to forming an antenna, and more particularly, to a method of forming a carrier having an antenna by sputtering and lithography.

2. Description of the Prior Art

Nowadays, due to the technical progress and the trend toward user-friendly commodities, flexible printed circuit boards (FPCBs) are employed by the antenna manufacture in a variety of communication electronic products, such as mobile devices including smart phones, mobile phones, notebooks, tablet personal computers, personal navigation devices (PNDs), global position system (GPS) devices, etc. However, when an FPCB is attached to a non-planar surface, especially a three-dimensional (3D) hyperboloid, part of the FPCB may rise off the non-planar surface because the FPCB can not fit the non-planar surface perfectly. It is more appropriate to use the FPCB in a single curved surface in 2.5-dimensional (2.5D) space, which is between the two-dimensional (2D) planar surface and the 3D space. Therefore, a Laser Direct Structuring (LDS) technique is commonly utilized when it is required to dispose an antenna on the non-planar surface.

The LDS technique is to use special plastics to implement a 3D hyperboloid antenna by three steps, which are injection molding, laser activation, and chemical plating. Besides reducing sizes of electronic devices, the LDS technique also enhances the communication quality to meet the requirement of modern electronic commodities. However, the LDS technique has certain drawbacks. For example, the process is more complicated, the machine for LDS is expensive, and the supply of special plastics of the antenna carrier body is limited to few suppliers. This increases the manufacturing cost, inevitably.

### SUMMARY OF THE INVENTION

Therefore, it is one of the objectives of the present invention to provide a method of forming an antenna. The method not only has a simple process and is not limited to the special plastics supply, but also meets the requirement of forming the antenna on any geometric surface.

According to an embodiment of the present invention, an exemplary method of forming an antenna is disclosed. The exemplary method includes: molding a supporting body, sputtering a conductive layer onto the supporting body, and defining a pattern of the antenna on the conductive layer.

The proposed method of forming the antenna of the present invention has certain advantages over the conventional design. For example, the process is simple, the limitation of the special plastics supply is avoided, the requirement of forming an antenna on any geometric surface is easily met, and the manufacturing cost is greatly decreased. Thus, the proposed method may be applied broadly to various electronic commodities.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart of an exemplary method of forming an antenna according to an embodiment of the present invention.

FIG. 2 is a section view of a carrier with an antenna that is formed by utilizing an exemplary method of forming the antenna according to an embodiment of the present invention.

FIG. 3 is a top view of the carrier shown in FIG. 2.

FIG. 4 is a section view of a carrier with an antenna that is formed by utilizing an exemplary method of forming the antenna according to another embodiment of the present invention.

FIG. 5 is a section view of a carrier with an antenna that is formed by utilizing an exemplary method of forming the antenna according to yet another embodiment of the present invention.

FIG. 6 is a flowchart of an exemplary method of forming an antenna according to another embodiment of the present invention.

FIG. 7 is a flowchart of an exemplary method of forming an antenna according to another embodiment of the present invention.

### DETAILED DESCRIPTION

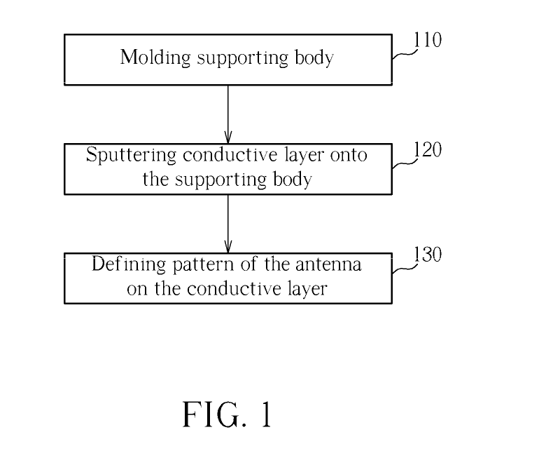

Please refer to FIG. 1, which is a flowchart of an exemplary method of forming an antenna according to an embodiment of the present invention. First, in step 110, a supporting body is formed, where materials of the supporting body may be composed of macromolecular materials or other plastics. Next, in step 120, a conductive layer is sputtered onto the supporting body, where the conductive layer may be metal, alloy, or conductive macromolecular materials. Finally, in step 130, a pattern of the antenna is defined on the conductive layer, where lithography technique, including dry etching, wet etching, or lift-off, is utilized in defining the pattern. In other words, the proposed method of forming the antenna of the present invention may be suitable for a dry process (e.g., a laser dry process performed to define the pattern of the antenna) and a wet process. The above techniques for defining the pattern of the antenna are for illustrative purposes only, and are not meant to be limitations of the present invention.

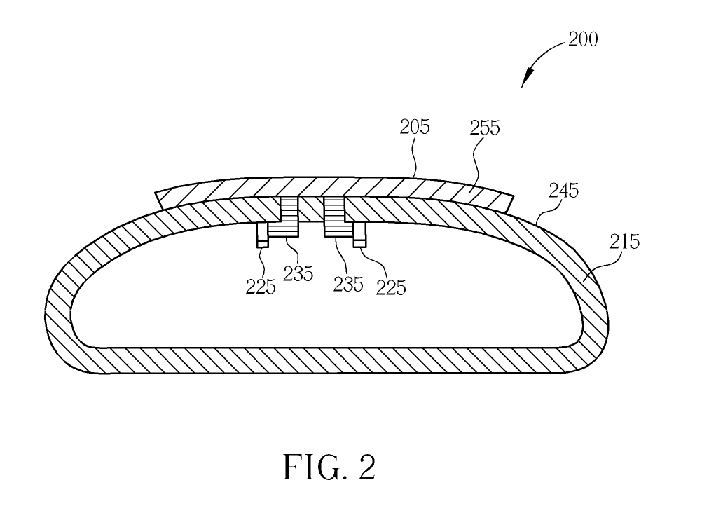

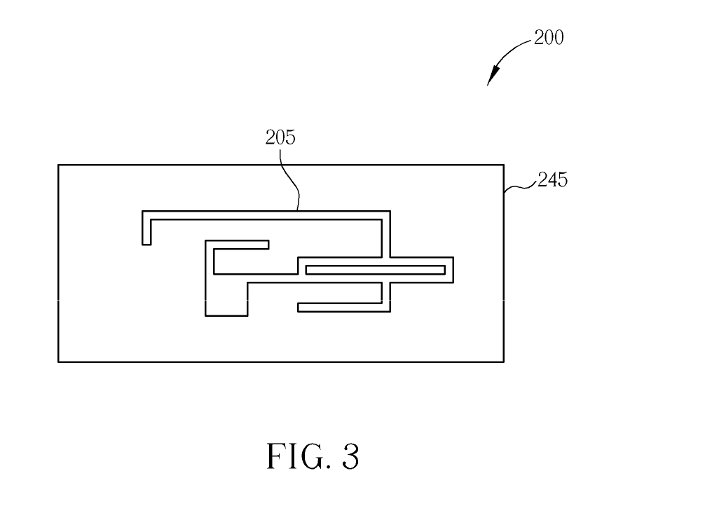

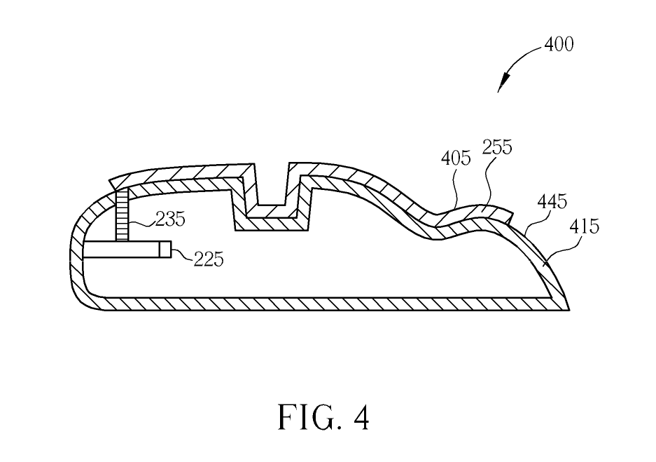

Please refer to FIG. 2 together with FIG. 3. FIG. 2 is a section view of a carrier 200 with an antenna that is formed by utilizing an exemplary method of forming the antenna according to an embodiment of the present invention, and FIG. 3 is a top view of the carrier 200 in FIG. 2. In this embodiment, a supporting body 215 is molded by injection molding, where the supporting body 215 comprises at least a contact object 225, at least a through hole 235, and at least a non-planar surface 245. Next, a conductive layer 255 is sputtered onto the non-planar surface 245. Finally, a pattern of an antenna 205 is defined by, but not limited to, etching or lift-off. In addition, when the pattern of the antenna 205 is defined by etching, a mask and/or photoresist may be used to pre-define the pattern of the antenna 205 according to the etching type such as dry etching or wet etching. The contact object 225 is electrically coupled to the antenna 205 via the through hole 235. In this embodiment, the non-planar surface 245 is simplified as a smoothly curved surface. In fact, as sputtering and lithography technology are not limited to the geometric surface type of the supporting body, the supporting body may have a combination of planes (e.g., planar surfaces) having at least two normal vectors with a predetermined included angle therebetween. Alternatively, the supporting body may have a combination of planes (e.g., planar surfaces) and curved surfaces (e.g., non-planar surfaces). For example, partial surfaces of the supporting body may be concave, wavy, stepped, and convex. Please refer to FIG. 4, which is a section view of a carrier with an antenna that is formed by utilizing an exemplary method of forming the antenna according to another embodiment of the present invention. The carrier 400 includes a supporting body 415, the contact object 225, the through hole 235, a non-planar surface 445, the conductive layer 255, and an antenna 405. As shown in FIG. 4, a carrier, having an antenna and including concave or wavy surfaces, may be formed by the exemplary method of forming the antenna according to the present invention. As the implementation steps of the carrier 400 are similar to those of the carrier 200, further description is omitted for brevity.

In an alternative design, the non-planar surface 245 of the supporting body 215 may be pre-processed for the process quality improvement before the conductive layer 255 is sputtered. For example, in order to enhance the adhesivity of the conductive layer 255 to the non-planar surface 245, a sandblasting process may be performed upon the non-planar surface 245. In brief, the spirit of the present invention is obeyed as long as the antenna is formed by sputtering the conductive layer onto the supporting body and then defining the pattern of the antenna.

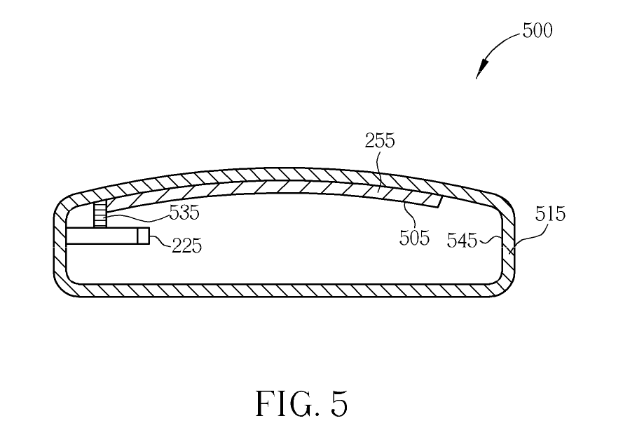

In addition, the method of forming an antenna according to the present invention may also be applied to an inner surface (i.e., a male mold surface). Please refer to FIG. 5, which is a section view of a carrier with an antenna that is formed by utilizing an exemplary method of forming the antenna according to yet another embodiment of the present invention. The carrier 500 includes a supporting body 515, the contact object 225, a contact point 535, a non-planar surface 545, the conductive layer 255, and an antenna 505. As the method of forming an antenna according to the present invention may be utilized on an outer surface (i.e., a female mold surface) and/or an inner surface, where each of the outer surface and the inner surface mentioned above may be a non-planar surface or a curved surface, the method of forming an antenna according to the present invention thus may meet the requirements of implementing antennas on various 3D curved surfaces. In other words, the method of forming an antenna according to the present invention may be applied to 2D, 3D, or 2.5D surfaces. In addition, as the implementation steps of the carrier 500 are similar to those of the carriers 200 and 400, further description is omitted for brevity.

Please refer to FIG. 2 again. Because the contact object 225 is electrically coupled to the antenna 205, an electrically conductive path is established between an electronic device (e.g., an integrated circuit substrate and a device acting as a signal source) and the antenna 205 when the electronic device is disposed to be electrically coupled to the contact object 225. Therefore, a carrier with an antenna, implemented using the exemplary method of forming an antenna according to the present invention, may be applied broadly to various electronic commodities (e.g., the above-mentioned mobile devices), and a frequency band supported by the formed antenna ranges from 200 Hz to 20 GHz. In addition, when the conductive layer 255 is sputtered onto the supporting body 215, the through hole 235 may be sealed simultaneously to thereby prevent the carrier 200 from undesired penetration of external moisture or other factors affecting the antenna quality. Moreover, in other embodiments, there may be through holes, reserved for other electronic devices or remained unused due to the process limitation, in the carrier having the antenna formed thereon. Therefore, in a variation of this embodiment, a bonding material (e.g., a macromolecular adhesive) may be used to seal these through holes to ensure the antenna quality.

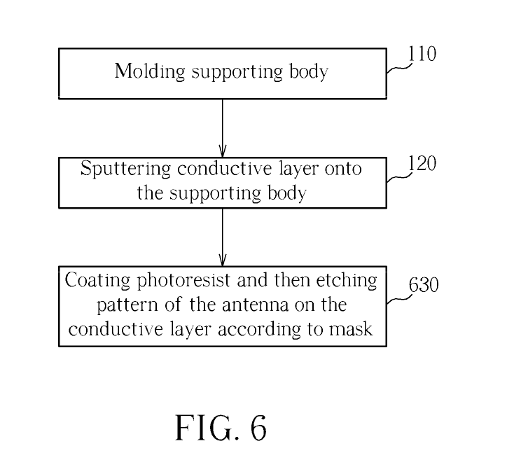

Please refer to FIG. 6, which is a flowchart of an exemplary method of forming an antenna according to another embodiment of the present invention. The flow shown in FIG. 6 is mainly based on that shown in FIG. 1, and therefore includes step 110, step 120, and step 630. In this embodiment, as a pattern of the antenna is defined on the conductive layer by dry etching, in step 630, photoresist is coated and the pattern of the antenna on the conductive layer is then etched according to a mask. Please note that the above is for illustrative purposes only, and is not meant to be a limitation to the present invention. In other words, based on the lithography technique used, a thin film may be used to replace the photoresist or mask for defining the pattern of the antenna on the conductive layer.

In another embodiment, after an antenna is formed, a post-process may be performed upon the formed antenna. By way of example, but not of limitation, the formed antenna may be processed to trim the pattern, enhance the hardness, and/or increase the conductivity. In an exemplary implementation, after the antenna is formed, metallization, electroless plating, sputtering, or chemical plating may be performed upon the formed antenna to form a thickened layer for improving the antenna quality such as hardness, abradability, and/or conductivity. In another exemplary implementation, a laser processing technique (e.g., a laser sculpture/marking technique) may be utilized to trim the formed antenna. It should be noted that a person skilled in the art can appreciate that the technique utilized to trim the formed antenna is not limited to the laser sculpture/marking technique.

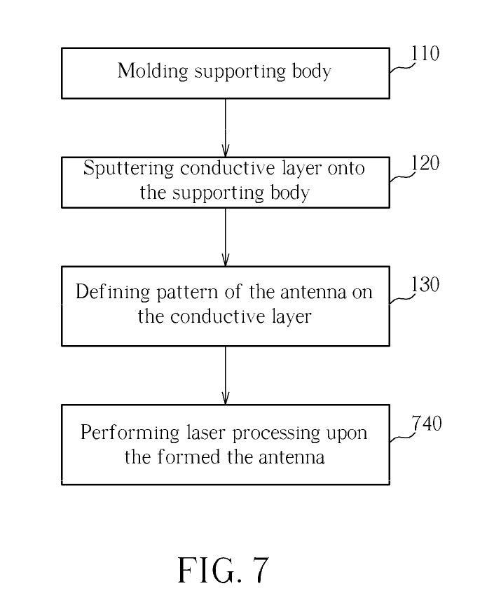

In addition to the trimming application, the laser processing technique may also be used to perform cutting, welding, and surface processing. In another embodiment, after an antenna is formed, the laser processing (e.g., the laser surface processing) may be utilized to improve the quality of the formed antenna. Please refer to FIG. 7, which is a flowchart of an exemplary method of forming an antenna according to another embodiment of the present invention. The flow shown in FIG. 7 is mainly based on that shown in FIG. 1, and the major difference is that the flow shown in FIG. 7 further includes performing a laser processing upon the formed antenna (as in step 740). As a person skilled in the art can readily understand details of each step shown in FIG. 7 after reading the above paragraphs, further description is omitted here for brevity.

In summary, the method of forming an antenna according to the present invention has certain advantages over the conventional design. For example, the process is simple, the limitation of special plastic supply is avoided, the requirement of forming an antenna on any geometric surface is easily met, and the manufacturing cost is greatly decreased. Thus, the proposed method may be applied broadly to various electronic commodities.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of forming an antenna, comprising:
molding a supporting body;
sputtering a conductive layer onto the supporting body; and
defining a pattern of the antenna on the conductive layer.

2. The method of claim 1, wherein the step of molding the supporting body comprises:
molding the supporting body having a non-planar surface.

3. The method of claim 2, wherein the step of defining the pattern of the antenna on the conductive layer comprises:
defining part of the pattern of the antenna on part of the conductive layer sputtered on the non-planar surface.

4. The method of claim 2, wherein the non-planar surface is a curved surface.

5. The method of claim 1, wherein the supporting body comprises:
at least a contact object, electrically coupled to the formed antenna.

6. The method of claim 5, wherein the supporting body further comprises:
a through hole, making the formed antenna penetrate through the through hole to electrically couple the contact object.

7. The method of claim 6, wherein the formed antenna penetrates through and seals the through hole to electrically couple the contact object.

8. The method of claim 6, further comprising:
utilizing a bonding material to seal the through hole.

9. The method of claim 1, wherein the step of defining the pattern of the antenna on the conductive layer comprises:
defining the pattern of the antenna on the conductive layer by dry etching.

10. The method of claim 1, wherein the step of defining the pattern of the antenna on the conductive layer comprises:
defining the pattern of the antenna on the conductive layer by wet etching.

11. The method of claim 1, wherein the step of defining the pattern of the antenna on the conductive layer comprises:
defining the pattern of the antenna on the conductive layer by lift-off.

12. The method of claim 1, wherein a frequency band supported by the formed antenna ranges from 200 Hz to 20 GHz.

13. The method of claim 1, further comprising:
performing metallization, electroless plating, sputtering, or chemical plating on the formed antenna.

14. The method of claim 1, further comprising:
trimming the formed antenna.

15. The method of claim 14, wherein the step of trimming the formed antenna comprises:
performing a laser processing to trim the formed antenna.

16. The method of claim 15, wherein the laser processing is a laser sculpture technique.

17. The method of claim 1, further comprising:
performing a laser processing upon the formed antenna.
